(19) United States
(12) Patent Application Publication
(10) Pub. No.: US 2014/0378589 A1
(43) Pub. Date: Dec. 25, 2014

(54) Silane Compound, Method for Preparing the Same, and Polycarbonate Resin Composition Including the Same

(71) Applicant: Cheil Industries Inc., Gumi-si (KR)

(72) Inventors: Su Hak BAE, Uiwang-si (KR); Sung Hee AHN, Uiwang-si (KR); Hyun Joo HAN, Uiwang-si (KR); Ha Na RA, Uiwang-si (KR); Hyun Ho LEE, Uiwang-si (KR)

(73) Assignee: Cheil Industries Inc., Gumi-si (KR)

(21) Appl. No.: 14/181,894

(22) Filed: Feb. 17, 2014

(30) Foreign Application Priority Data
Jun. 25, 2013 (KR) 10-2013-0073347
Dec. 13, 2013 (KR) 10-2013-0155764

(51) Int. Cl. C08G 64/06; C08L 69/00

(52) U.S. Cl. CPC C08G 64/06; C08L 69/00
USPC 524/114; 525/461; 524/451; 524/449

(57) ABSTRACT

A silane compound is represented by Formula 1:

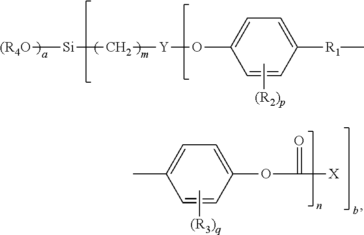

wherein each R₁ is independently a single bond, an ether group, a carbonyl group, a thioether group, a sulfone group, or a substituted or unsubstituted C₁ to C₂₀ hydrocarbon group, R₂ and R₃ are each independently a substituted or unsubstituted C₁ to C₂₀ hydrocarbon group, each R₄ is independently hydrogen or a C₁ to C₅ hydrocarbon group, each X is independently halogen, a hydroxyl group, or C₁ to C₂₀ alkoxy, each Y is independently a single bond, an amide group, a thioester group, a hydroxyethylene group, a carbonyl group, an aromatic group or an ester group, a and b are each independently an integer from 1 to 3, a+b is 4, m is an integer from 0 to 5, n is an integer from 5 to 50, and p and q are each independently an integer from 0 to 4.

### CROSS-REFERENCE TO RELATED APPLICATION

This application claims priority under 35 USC Section 119 to and the benefit of Korean Patent Application No. 10-2013-0073347, filed Jun. 25, 2013, and Korean Patent Application No. 10-2013-0155764, filed Dec. 13, 2013, the entire disclosure of each of which is incorporated herein by reference.

### FIELD OF THE INVENTION

The present invention relates to a silane compound, a method for preparing the same, and a polycarbonate resin composition including the same. More particularly, the present invention relates to a silane compound having a novel structure, a method for preparing the same, and a polycarbonate resin composition that can have an excellent appearance, rigidity, and the like with minimal or no deterioration in flowability through use of the same.

### BACKGROUND OF THE INVENTION

When a thermoplastic resin or a thermosetting resin is blended with inorganic fillers such as glass fibers, silica, talc, and the like, the resin may have improved tearing strength, tensile strength, flexural strength, flexural modulus, and the like due to the inherent properties of the inorganic filler. Blending of a thermoplastic resin such as polycarbonate and the like with inorganic fillers is usually performed in a process of preparing a molded article requiring high rigidity. Particularly, the blend can be used as an interior/exterior material for automobiles as well as electric and electronic products.

However, when the resin is blended with inorganic fillers, the resin may have problems during injection molding due to reduced moldability. Specifically, when the resin is injection molded, there is a possibility that inorganic fillers such as glass fibers and the like may protrude from the surface of a molded article, which leads to deterioration in appearance. Thus, the resin is limited to use for production of indoor articles in practice.

Further, when flowability of a thermoplastic resin composition blended with inorganic fillers such as glass fibers and the like is improved, appearance may be enhanced, but there are problems in that mechanical and thermal properties of the resin composition can decrease with the increase of flowability.

Korean Patent Publication No. 10-2012-0075813A discloses a glass fiber-reinforced polycarbonate resin composition including a glass fiber-reinforced polycarbonate resin, a metal salt flame retardant, a fluorinated polyolefin resin, and a mixture of a siloxane compound and a silicone resin composition, and having excellent flame retardancy. Further, Korean Patent Publication No. 10-2012-0057276A discloses a glass fiber-reinforced polycarbonate resin composition having enhanced color stability at high temperatures. These resin compositions can enhance rigidity and flame retardancy through glass fiber reinforcement. However, these resins are poorly suited for exterior applications due to rapid deterioration in appearance over time.

In order to enhance appearance, injection molding such as rapid heat cycle molding (RHCM) and the like may be used. However, this method requires an expensive injection machine and a long molding cycle period, which can reduce productivity.

### SUMMARY OF THE INVENTION

The present invention provides a novel silane compound, a method for preparing the same and a polycarbonate resin composition than can have excellent rigidity and appearance with minimal or no deterioration in flowability through use of the silane compound.

The silane compound is represented by Formula 1:

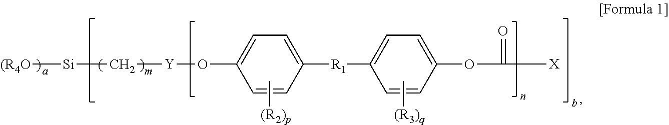

wherein each R₁ is independently a single bond, an ether group, a carbonyl group, a thioether group, a sulfone group, or a substituted or unsubstituted C₁ to C₂₀ hydrocarbon group, R₂ and R₃ are the same or different and are each independently a substituted or unsubstituted C₁ to C₂₀ hydrocarbon group, each R₄ is independently hydrogen or a C₁ to C₅ hydrocarbon group, each X is independently halogen, a hydroxyl group, or C₁ to C₂₀ alkoxy, each Y is independently a single bond, an amide group, a thioester group, a hydroxyethylene group, a carbonyl group, an aromatic group or an ester group, a and b are the same or different and are each independently an integer from 1 to 3, a+b is 4, m is an integer from 0 to 5, n is an integer from 5 to 50, and p and q are the same or different and are each independently an integer from 0 to 4.

In one embodiment, each Y may independently be a single bond, an amide group, or a hydroxyethylene group.

In one embodiment, the silane compound may have a weight average molecular weight from about 2,000 g/mol to about 17,000 g/mol.

The present invention also relates to a method for preparing the silane compound. The preparation method includes: reacting a silane compound represented by Formula 2 with an aromatic carbonate compound represented by Formula 3.

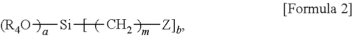

wherein R₄, a, b and m are as defined in the formula 1, and each Z is independently halogen, an isocyanate group, a thiocyanate group, an epoxy group, a carboxyl group, or a halogenated carbonyl group.

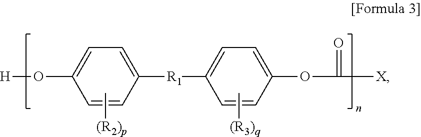

wherein R₁, R₂, R₃, X, n, p and q are as defined in Formula 1.

In one embodiment, reaction may be performed by heating and stirring at a temperature of about 30° C. to about 110° C. in the presence of an organic solvent.

The present invention also relates to a polycarbonate resin composition. The polycarbonate resin composition includes: a polycarbonate resin; a silane compound represented by Formula 1; and an inorganic filler.

In one embodiment, the silane compound may be present in an amount of about 1 part by weight to about 20 parts by weight, and the inorganic filler may be present in an amount of about 5 parts by weight to about 50 parts by weights, each based on about 100 parts by weight of the polycarbonate resin.

The silane compound and the inorganic filler may be present in a weight ratio of about 1:about 4 to about 1:about 30.

In one embodiment, the inorganic filler may include at least one of silica, talc, glass fibers, mica, wollastonite, basalt fibers, and/or whiskers.

In one embodiment, a portion or the entirety of the silane compound may be chemically bonded to the inorganic filler.

In one embodiment, the polycarbonate resin composition may have a tensile strength of about 800 kgf/cm² to about 1,500 kgf/cm² measured in accordance with ASTM D638, a flexural strength of about 1,200 kgf/cm² to about 2,000 kgf/cm² measured in accordance with ASTM D790, a flexural modulus of about 30,000 kgf/cm² to about 110,000 kgf/cm² measured in accordance with ASTM D790, an Izod impact strength of about 5 kgf·cm/cm to about 16 kgf·cm/cm as measured on a ⅛″ thick specimen in accordance with ASTM D256, an FDI (falling dart impact) strength of about 10 J to about 40 J as measured on an about 1 mm thick specimen in accordance with the DuPont drop test method, and a melt flow index (MI) of about 10 g/10 min to about 80 g/10 min as measured in accordance with ASTM D1238.

### BRIEF DESCRIPTION OF THE DRAWINGS

FIG. 1 is an ¹H-NMR spectrum of a silane compound prepared in Preparative Example 1.

FIG. 2 depicts micrographs of specimens captured using an optical microscope at a central surface region (2 cm×2 cm) of the injection molded specimens (6 cm×6 cm) of polycarbonate compositions prepared in Examples and Comparative Examples, in which the appearance of each specimen was graded on a scale of 1 to 10.

### DETAILED DESCRIPTION OF THE INVENTION

The present invention now will be described more fully hereinafter in the following detailed description of the invention, with reference to the accompanying drawings, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The silane compound of the present invention is represented by Formula 1:

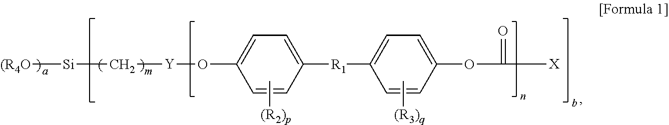

wherein each R₁ is independently a single bond, an ether group (—O—), a carbonyl group (—CO—), a thioether group (—S—), a sulfone group (—SO₂—), or a substituted or unsubstituted C₁ to C₂₀ hydrocarbon group, for example, C₁ to C₁₅ alkylene, C₁ to C₁₅ alkylidene, or C₅ to C₁₅ cycloalkylidene, R₂ and R₃ are the same or different and are each independently a substituted or unsubstituted C₁ to C₂₀ hydrocarbon group, for example, C₁ to C₁₅ alkyl, C₁ to C₁₅ alkoxy, C₃ to C₁₅ cycloalkyl, C₃ to C₁₅cycloalkoxy, C₆ to C₁₅ aryl or C₆ to C₁₅ aryloxy, for example, methyl, ethyl, methoxy, or ethoxy, each R₄ is independently hydrogen or a C₁ to C₅ hydrocarbon group, for example, methyl, ethyl, propyl, butyl, and the like, each X is independently, halogen such as chlorine (Cl), bromine (Br) and the like, a hydroxyl group, or C₁ to C₂₀ alkoxy, for example, C₁ to C₁₅ alkoxy, each Y is independently a single bond, an amide group (—NH—CO—), a thioester group (—S—CO—), a hydroxyethylene group (—C(OH)—CH₂—), a carbonyl group (—CO—), an aromatic group or an ester group (—O—CO—), and the like, for example, a single bond, an amide group, or a hydroxyethylene group, a and b are the same or different and are each independently an integer from 1 to 3, a+b is 4, for example, a may be 3 and b may be l, m is an integer from 0 to 5, n is an integer from 5 to 50, for example, 7 to 30, and as another example, 10 to 25, and p and q are the same or different and are each independently an integer from 0 to 4.

As used herein, the term “substituted” means that a hydrogen atom is substituted with a substituent including halogen, C₁ to C₃₀ alkyl, C₁ to C₃₀ haloalkyl, C₆ to C₃₀ aryl, C₂ to C₃₀ heteroaryl, C₁ to C₂₀ alkoxy, or a combination thereof.

As used herein, the term “substituted or unsubstituted C₁ to C₂₀ hydrocarbon group” can refer to, for example, substituted or unsubstituted C₁ to C₁₅ alkylene, C₁ to C₁₅ alkylidene, C₅ to C₁₅ cycloalkylidene, C₁ to C₁₅ alkyl, C₁ to C₁₅ alkoxy, C₃ to C₁₅ cycloalkyl, C₃ to C₁₅cycloalkoxy, C₆ to C₁₅ aryl and/or C₆ to C₁₅ aryloxy. Also as used herein, the term “aromatic group” can refer to, for example, substituted or unsubstituted C₆ to C₁₅ aryl.

In one embodiment, the silane compound can have a weight average molecular weight (Mw) of about 2,000 g/mol to about 17,000 g/mol, as measured by gel permeation chromatography (GPC), without being limited thereto.

The method for preparing the silane compound according to the present invention includes: reacting a silane compound represented by Formula 2 with an aromatic carbonate compound represented by Formula 3.

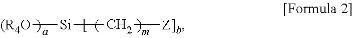

wherein R₄, a, b and m are as defined in Formula 1, and each Z is independently halogen such as chlorine (Cl), bromine (Br) and the like, an isocyanate group (—N═C═O), a thiocyanate group (—S═C═O), an epoxy group, a carboxyl group (—CO—OH), a halogenated carbonyl group (—CO—R′: R′=a halogen atom), and the like, for example, halogen, an isocyanate group, an epoxy group, and the like.

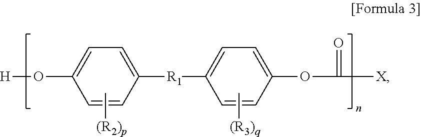

wherein R₁, R₂, R₃, X, n, p and q are as defined in Formula 1.

In one embodiment, reaction may be performed by heating and stirring at a temperature of about 30° C. to about 110° C., for example, at about 60° C. to about 100° C., in the presence of an organic solvent for about 1 hour to about 48 hours.

Examples of the organic solvent may include without limitation tetrahydrofuran (THF), 1,4-dioxane, dichloromethane (CH₂Cl₂), trichloromethane (CHCl₃), chlorobenzene, and the like, and mixtures thereof. For example, tetrahydrofuran and/or 1,4-dioxane may be used as the organic solvent.

The organic solvent may be used in an amount of about 200 parts by weight to about 1,000 parts by weight, based on about 100 parts by weight of the silane compound represented by Formula 2 and the aromatic carbonate compound represented by Formula 3, without being limited thereto.

Furthermore, the reaction may be performed in the presence of a catalyst, if necessary. Examples of the catalyst may include, without limitation, an amine catalyst, such as pyridine, triethylamine, diethylamine, and the like, and mixtures thereof. The catalyst may be used in an amount of about 0.1 parts by weight to about 30 parts by weight, based on about 100 parts by weight of the silane compound represented by Formula 2 and the aromatic carbonate compound represented by Formula 3, without being limited thereto.

In one embodiment, the molar ratio of the compound represented by Formula 2 to the aromatic carbonate compound represented by Formula 3 may depend upon the amount of the silane compound. For example, the molar ratio may be about 1:about 1 to about 1:about 10.

The polycarbonate resin composition according to the present invention may include a polycarbonate resin, a silane compound represented by Formula 1, and an inorganic filler.

As used herein, the polycarbonate resin can be a typical thermoplastic polycarbonate resin. For example, an aromatic polycarbonate resin prepared by reacting one or more diphenols (diol compounds) with phosgene, halogen formate and/or carbonate diester may be used as the polycarbonate resin.

Examples of the diphenols may include without limitation 4,4′-bipenol, 2,2-bis(4-hydroxyphenyl)propane, 2,4-bis(4-hydroxyphenyl)-2-methylbutane, 1,1-bis(4-hydroxyphenyl)cyclohexane, 2,2-bis(3-chloro-4-hydroxyphenyl)propane, 2,2-bis(3,5-dichloro-4-hydroxyphenyl)propane, and the like, and mixtures thereof. For example, the diphenol may include 2,2-bis(4-hydroxyphenyl)propane, 2,2-bis(3,5-dichloro-4-hydroxyphenyl)propane, and/or 1,1-bis(4-hydroxyphenyl)cyclohexane, for example, 2,2-bis(4-hydroxyphenyl)propane, which is referred to as bisphenol-A.

The polycarbonate resin may have a branched chain, and may be prepared, for example, by adding about 0.05 mol % to about 2 mol % of a tri- or more polyfunctional compound, for example, a compound having three or more phenol groups.

The polycarbonate resin may be used in the form of a homo polycarbonate resin, a co-polycarbonate resin, or a blend thereof.

Furthermore, the polycarbonate resin may be replaced partially or wholly with an aromatic polyester-carbonate resin obtained by polymerization in the presence of an ester precursor, for example, bifunctional carboxylic acid.

The polycarbonate resin may have a weight average molecular weight (Mw) of about 10,000 g/mol to about 200,000 g/mol, for example, about 15,000 g/mol to about 80,000 g/mol, without being limited thereto.

In this invention, the silane compound represented by Formula 1 may serve as a compatibilizer or a coupling agent in the polycarbonate resin composition, which enhances interface adhesion between the polycarbonate and the inorganic filler while increasing rigidity with minimal or no deterioration in flowability.

In one embodiment, the silane compound may be present in an amount of about 1 part by weight to about 20 parts by weight, for example, about 2 parts by weight to about 10 parts by weight, based on about 100 parts by weight of the polycarbonate resin. In some embodiments, the polycarbonate resin composition may include the silane compound in an amount of about 1, 2, 3, 4, 5, 6, 7, 8, 9, 10, 11, 12, 13, 14, 15, 16, 17, 18, 19, or 20 parts by weight. Further, according to some embodiments of the present invention, the amount of the silane compound can be in a range from about any of the foregoing amounts to about any other of the foregoing amounts.

When the polycarbonate resin composition includes the silane compound in an amount within this range, the polycarbonate resin composition can exhibit excellent rigidity with minimal or no deterioration in flowability.

As used herein, the inorganic filler refers to a material capable of forming a chemical bond through condensation with a hydroxyl group of the silane compound. Examples of the inorganic filler may include without limitation silica, talc, glass fibers, mica, wollastonite, basalt fibers, whiskers, and the like and mixtures thereof. For example, the inorganic filler may include silica, talc, glass fibers, mica, basalt fibers, or a mixture thereof.

In one embodiment, the inorganic filler may have an average particle size of, for example, about 50 nm to about 100 μm, without being limited thereto.

In one embodiment, the glass fibers may refer to a glass fiber reinforcing agent in which glass filaments coated with a sizing agent such as an epoxy, urethane, silane and the like form fibers. The glass filaments may have an average diameter (D) of about 5 μm to about 20 μm (aspect ratio (L/D): about 5˜about 60). The glass fiber reinforcing agent may have an average diameter (D) of about 10 μm to about 13 μm (aspect ratio (L/D): about 5˜about 60), without being limited thereto. Further, the sizing agent may be present in an amount of about 0.05 parts by weight to about 0.1 parts by weight, based on about 100 parts by weight of the glass filament.

In one embodiment, the inorganic filler may be present in an amount of about 5 parts by weight to about 50 parts by weight, for example, about 10 parts by weight to about 30 parts by weight, based on about 100 parts by weight of the polycarbonate resin. In some embodiments, the polycarbonate resin composition may include the inorganic filler in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 parts by weight. Further, according to some embodiments of the present invention, the amount of the inorganic filler can be in a range from about any of the foregoing amounts to about any other of the foregoing amounts.

When the polycarbonate resin composition includes the inorganic filler in an amount within this range, the resin composition can exhibit excellent appearance and rigidity with minimal or no deterioration in flowability.

In addition, the weight ratio of the silane compound to the inorganic filler (silane compound:inorganic filler) may be about 1:about 4 to about 1:about 30, for example, about 1:about 4 to about 1:about 20. Within this range, the resin composition can exhibit further enhanced rigidity, flowability, appearance, and the like.

The thermoplastic resin composition according to the invention may further include one or more additives such as but not limited to flame retardant aids, lubricants, plasticizers, heat stabilizers, anti-dripping agents, antioxidants, compatibilizers, light stabilizers, pigments, dyes, and the like, as needed. These additives may be used alone or in combination thereof. For example, the additives may be used in an amount of about 0.1 parts by weight to about 10 parts by weight based on about 100 parts by weight of the base resin, without being limited thereto.

In the polycarbonate resin composition of the present invention, a portion or the entirety of the silane compound may be chemically bonded to the inorganic filler. For example, the polycarbonate resin composition may be obtained in pellet form by mixing the components and melt-extruding the mixture in a typical twin-screw extruder at a temperature of about 200° C. to about 280° C., for example, about 250° C. to about 260° C. At this extrusion temperature, a silane group of the silane compound and a hydroxyl group of the inorganic filler may undergo condensation to form covalent bonding on the surface of the inorganic filler, followed by dehydration condensation during extrusion and drying.

The pelletized resin composition may be used to produce various molded articles through various molding methods, such as injection molding, extrusion molding, vacuum molding, cast molding, and the like. These methods are well-known to those skilled in the art.

In one embodiment, the polycarbonate resin composition may have a tensile strength of about 800 kgf/cm² to about 1,500 kgf/cm², for example, about 800 kgf/cm² to about 1,200 kgf/cm², and as another example, about 900 kgf/cm² to about 1,000 kgf/cm² measured in accordance with ASTM D638, a flexural strength of about 1,200 kgf/cm² to about 2,000 kgf/cm², for example, about 1,300 kgf/cm² to about 1,800 kgf/cm² measured in accordance with ASTM D790, and/or a flexural modulus of about 30,000 kgf/cm² to about 110,000 kgf/cm², for example, about 40,000 kgf/cm² to about 75,000 kgf/cm² also as measured in accordance with ASTM D790.

Further, the polycarbonate resin composition may have an Izod impact strength of about 5 kgf/cm² to about 16 kgf/cm², as measured on an about ⅛″ thick specimen in accordance with ASTM D256.

The polycarbonate resin composition may have an FDI (falling dart impact) strength of about 10 J to about 40 J, for example, about 20 J to about 30 J, as measured on an about 1 mm thick specimen (about 10 cm×about 10 cm×about 1 mm) using 2 kg dart in accordance with the DuPont drop test method. In this FDI strength test, a dart having a predetermined weight is dropped onto an about 1 mm thick specimen from an adjusted height to observe the occurrence of cracking with the naked eye. The maximum height at which cracking does not occur is measured to calculate potential energy (DuPont drop test method).

Further, the polycarbonate resin composition may have a melt flow index (MI) of about 10 g/10 min to about 80 g/10 min, for example, about 20 g/10 min to about 50 g/10 min, as measured in accordance with ASTM D1238.

Next, the present invention will be explained in more detail with reference to the following examples. However, it should be understood that these examples are provided for illustration only and are not to be in any way construed as limiting the present invention. Descriptions of details apparent to those skilled in the art will be omitted herein.

### EXAMPLES

### Preparative Example 1

### Preparation of Silane Compound

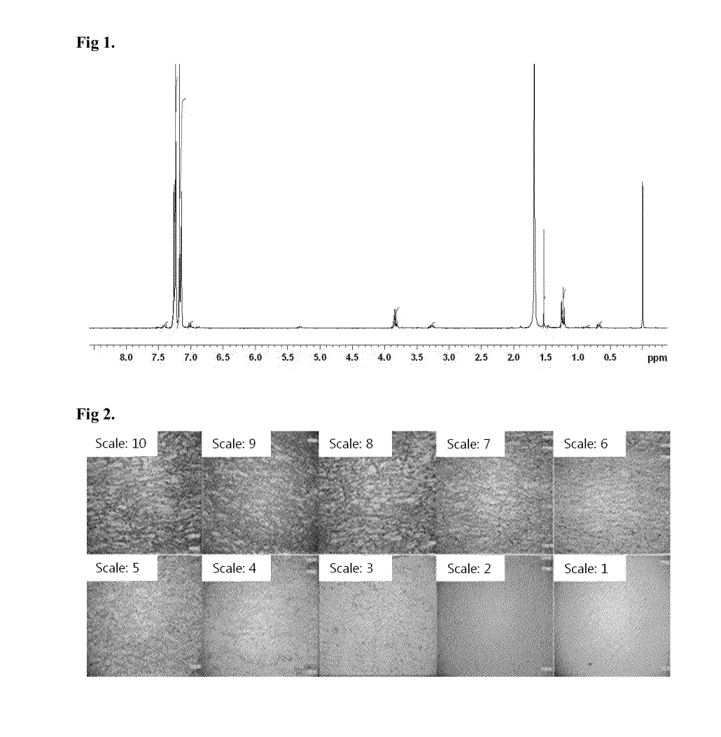

240 g (1.0 mole) of a silane compound represented by Formula 2a and 760 g (0.3 mole) of an aromatic carbonate compound (n=10) represented by Formula 3a are dissolved in 1,4-dioxane solvent and stirred at 100° C. for 24 hours to prepare a silane compound (n=10) represented by Formula 1a (yield: 99%, weight average molecular weight (measured by GPC): 5,300 g/mol). An ¹H-NMR spectrum of the prepared a silane compound represented by Formula 1a is measured, and results are shown in FIG. 1.

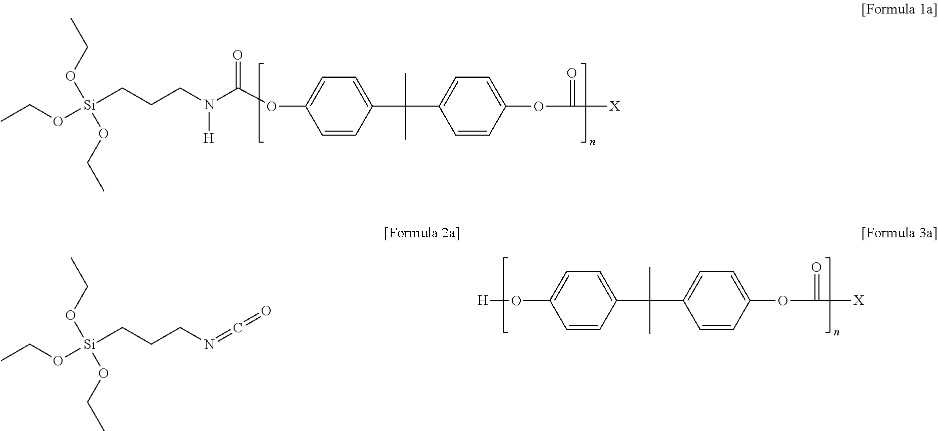

In Formulas 1a and 3a, X is as defined in Formula 1.

### Preparative Example 2

### Preparation of Silane Compound

A silane compound (n=20) represented by Formula 1a is prepared in the same manner as in Preparative Example 1 except that 760 g (0.15 mole) of the aromatic carbonate compound (n=20) represented by Formula 3a is used instead of 760 g (0.3 mole) of the aromatic carbonate compound (n=10) represented by Formula 3a (yield: 98%, weight average molecular weight: 10,300 g/mol).

### Preparative Example 3

### Preparation of Silane Compound

A silane compound (n=30) represented by Formula 1a is prepared in the same manner as in Preparative Example 1 except that 760 g (0.1 mole) of the aromatic carbonate compound (n=30) represented by Formula 3a is used instead of 760 g (0.3 mole) of the aromatic carbonate compound (n=10) represented by Formula 3a (yield: 96%, weight average molecular weight: 15,300 g/mol).

Details of the components used in the Examples and Comparative Examples are as follows.

(A) Polycarbonate resin

A bisphenol-A polycarbonate (SC-1190, Cheil Industries, Co. Ltd., Melt index (MI, measured at 300° C. under a load of 1.2 kg in accordance with ISO 1133): 20 g/10 min) is used.

(B) Silane compound

Silane compounds ((B1) to (B3)) prepared in Preparative Examples 1 to 3 are used.

(C) Inorganic filler

(C1) Talc (KC-3000, Coach Co. Ltd.)

(C2) Mica (200-HK, Suzolite)

(C3) Glass fibers: Epoxy-coated glass fiber reinforcing agent (CS321, KCC)

### Examples 1 to 8 and Comparative Examples 1 to 6

The components are mixed in amounts as listed in Tables 1 and 2, followed by extrusion of the mixture at 200° C. to 280° C. to prepare pellets. A twin-screw extruder having a diameter of 45 mm and L/D=36 is used for extrusion. The prepared pellets are dried at 70° C. for 2 hours and injection-molded in a 6 oz injection molding machine (molding temperature: 290° C., mold temperature: 60° C.) to prepare specimens. The physical properties of the prepared specimens are evaluated as follows. Results are shown in Tables 1 and 2.

Measurement of Physical Properties

(1) Izod impact strength (unit: kgf·cm/cm): Izod impact strength is measured on a ⅛″ thick notched Izod specimen in accordance with ASTM D256.

(2) FDI (Falling Dart Impact) strength (unit: J): FDI strength is measured by dropping a 2 kg dart onto a 1 mm thick specimen (10 cm×10 cm×1 mm) and measuring the height of dart, at which cracking does not occur, to calculate potential energy in accordance with DuPont drop test method.

(3) Tensile strength (unit: kgf/cm²): Tensile strength is measured at 5 mm/minute in accordance with ASTM D638.

(4) Flexural modulus and flexural strength (unit: kgf/cm²): Flexural modulus and flexural strength are measured at 2.8 mm/minute in accordance with ASTM D790.

(5) Melt flow index (MI, unit: g/10 minutes): Melt flow index is measured at 300° C. and under a load of 5 kg in accordance with ASTM D1238.

(6) Appearance evaluation: A central surface region (2 cm×2 cm) of an injection-molded specimen (6 cm×6 cm) is observed using an optical microscope. FIG. 2 depicts photographs of specimens, in which central surface regions (2 cm×2 cm) of injection-molded specimens (6 cm×6 cm) of the polycarbonate compositions prepared in Examples and Comparative Examples are photographed and appearance is evaluated on a scale of 1 to 10, 1 being the best (excellent) and 10 being the worst (poor).

TABLE 1

| | | Example | | | | | | | |
|---|---|---|---|---|---|---|---|---|---|
| | | 1 | 2 | 3 | 4 | 5 | 6 | 7 | 8 |
| (A) Polycarbonate | | 100 | 100 | 100 | 100 | 100 | 100 | 100 | 100 |
| (B) Silane-based compound | (B1) | 2 | 4 | 6 | 6 | 6 | 6 | — | — |
| | (B2) | — | — | — | — | — | — | 4 | — |
| | (B3) | — | — | — | — | — | — | — | 4 |
| (C) Inorganic filler | (C1) | 25 | 25 | 25 | — | 10 | — | 25 | 25 |
| | (C2) | — | — | — | 25 | — | — | — | — |
| | (C3) | — | — | — | — | 15 | 30 | — | — |

| | | | | | | | | |
|---|---|---|---|---|---|---|---|---|
| Izod impact strength | 6.0 | 7.5 | 9.5 | 9.0 | 10 | 15 | 7.0 | 7.1 |
| FDI strength | 20 | 26 | 32 | 30 | 20 | 15 | 24 | 22 |
| Tensile strength | 960 | 1000 | 1100 | 1150 | 1200 | 1400 | 1050 | 1060 |
| Flexural strength | 1580 | 1600 | 1620 | 1650 | 1750 | 1800 | 1590 | 1620 |
| Flexural modulus | 52000 | 51000 | 51500 | 59000 | 60000 | 73000 | 52000 | 51000 |
| Melt index | 50 | 48 | 47 | 48 | 40 | 36 | 45 | 42 |
| Appearance | 2 | 1 | 1 | 2 | 3 | 5 | 2 | 2 |
| (Scale of 1 to 10) | | | | | | | | |

Units: parts by weight

TABLE 2

| | | Comparative Example | | | | | |
|---|---|---|---|---|---|---|---|
| | | 1 | 2 | 3 | 4 | 5 | 6 |
| (A) Polycarbonate | | 100 | 100 | 100 | 100 | 100 | 100 |
| (C) Inorganic filler | (C1) | 25 | — | 10 | — | 10 | — |
| | (C2) | — | 25 | — | — | — | 10 |
| | (C3) | — | — | 15 | 30 | — | — |

| | | | | | | |
|---|---|---|---|---|---|---|
| Izod impact strength | 4.0 | 3.5 | 7.0 | 11 | 6.0 | 5.5 |
| FDI strength | 8 | 4 | 5 | 5 | 15 | 15 |
| Tensile strength | 800 | 850 | 1100 | 1200 | 650 | 680 |
| Flexural strength | 1450 | 1500 | 1600 | 1750 | 900 | 920 |
| Flexural modulus | 52000 | 55000 | 58000 | 71000 | 28000 | 31000 |
| Flow Index | 48 | 45 | 38 | 35 | 75 | 70 |
| Appearance | 2 | 2 | 6 | 10 | 1 | 1 |
| (scale of 1 to 10) | | | | | | |

Unit: parts by weight

From the above results, it can be seen that the polycarbonate resin compositions including the silane compound of the present invention exhibit excellent rigidity, flowability, and appearance with a scale of 1 to 5.

Conversely, the polycarbonate resin compositions of Comparative Examples, which do not include the silane compound, have low Izod impact strength and FDI strength (Comparative Examples 1 and 2) or low tensile strength, flexural strength or flexural modulus (Comparative Examples 5 and 6), as compared to the polycarbonate resin compositions of the present invention. In addition, when glass fibers (C3) are used as the inorganic filler, the composition has decreased FDI strength, flowability and appearance (Comparative Examples 3 and 4).

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims.

What is claimed is:

1. A silane compound represented by Formula 1: 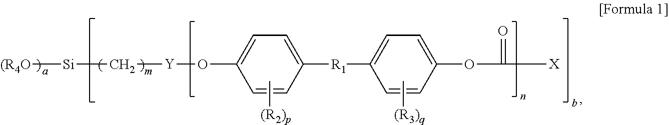
wherein each R₁ is independently a single bond, an ether group, a carbonyl group, a thioether group, a sulfone group, or a substituted or unsubstituted C₁ to C₂₀ hydrocarbon group, R₂ and R₃ are the same or different and are each independently a substituted or unsubstituted C₁ to C₂₀ hydrocarbon group, each R₄ is independently hydrogen or a C₁ to C₅ hydrocarbon group, each X is independently halogen, a hydroxyl group, or C₁ to C₂₀ alkoxy, each Y is independently a single bond, an amide group, a thioester group, a hydroxyethylene group, a carbonyl group, an aromatic group or an ester group, a and b are the same or different and are each independently an integer from 1 to 3, a+b is 4, m is an integer from 0 to 5, n is an integer from 5 to 50, and p and q are the same or different and are each independently an integer from 0 to 4.

2. The silane compound according to claim 1, wherein each Y is independently a single bond, an amide group, or a hydroxyethylene group.

3. The silane compound according to claim 1, wherein the silane compound has a weight average molecular weight from about 2,000 g/mol to about 17,000 g/mol.

4. A method for preparing a silane compound of Formula 1, comprising: reacting a silane compound represented by Formula 2 with an aromatic carbonate compound represented by Formula 3. 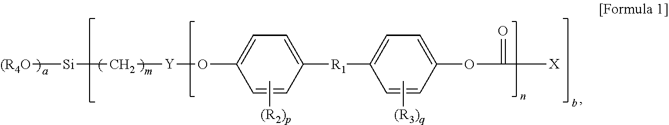
wherein each R₁ is independently a single bond, an ether group, a carbonyl group, a thioether group, a sulfone group, or a substituted or unsubstituted C₁ to C₂₀ hydrocarbon group, R₂ and R₃ are the same or different and are each independently a substituted or unsubstituted C₁ to C₂₀ hydrocarbon group, each R₄ is independently hydrogen or a C₁ to C₅ hydrocarbon group, each X is independently halogen, a hydroxyl group, or C₁ to C₂₀ alkoxy, each Y is independently a single bond, an amide group, a thioester group, a hydroxyethylene group, a carbonyl group, an aromatic group or an ester group, a and b are the same or different and are each independently an integer from 1 to 3, a+b is 4, m is an integer from 0 to 5, n is an integer from 5 to 50, and p and q are the same or different and are each independently an integer from 0 to 4; 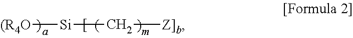
wherein R₄, a, b and m are as defined in formula 1, and each Z is independently halogen, an isocyanate group, a thiocyanate group, an epoxy group, a carboxyl group, or a halogenated carbonyl group; 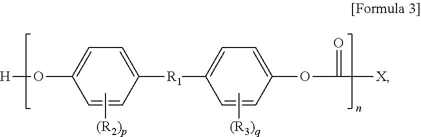
wherein R₁, R₂, R₃, X, n, p and q are as defined in formula 1.

5. The method according to claim 4, wherein the reaction is performed by heating and stirring at a temperature of about 30° C. to about 110° C. in the presence of an organic solvent.

6. A polycarbonate resin composition, comprising:
a polycarbonate resin;
a silane compound of Formula 1; and
an inorganic filler. 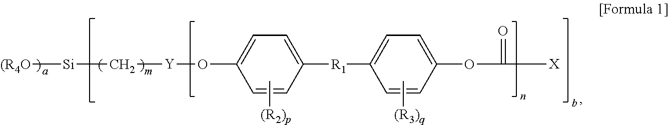
wherein each R₁ is independently a single bond, an ether group, a carbonyl group, a thioether group, a sulfone group, or a substituted or unsubstituted C₁ to C₂₀ hydrocarbon group, R₂ and R₃ are the same or different and are each independently a substituted or unsubstituted C₁ to C₂₀ hydrocarbon group, each R₄ is independently hydrogen or a C₁ to C₅ hydrocarbon group, each X is independently halogen, a hydroxyl group, or C₁ to C₂₀ alkoxy, each Y is independently a single bond, an amide group, a thioester group, a hydroxyethylene group, a carbonyl group, an aromatic group or an ester group, a and b are the same or different and are each independently an integer from 1 to 3, a+b is 4, m is an integer from 0 to 5, n is an integer from 5 to 50, and p and q are the same or different and are each independently an integer from 0 to 4.

7. The polycarbonate resin composition according to claim 6, comprising: about 1 part by weight to about 20 parts by weight of the silane compound, and about 5 parts by weight to about 50 parts by weights of the inorganic filler, each based on about 100 parts by weight of polycarbonate resin.

8. The polycarbonate resin composition according to claim 7, wherein the silane compound and the inorganic filler are present in a weight ratio of about 1:about 4 to about 1:about 30.

9. The polycarbonate resin composition according to claim 6, wherein the inorganic filler comprises silica, talc, glass fibers, mica, wollastonite, basalt fibers, whiskers, or a mixture thereof.

10. The polycarbonate resin composition according to claim 6, wherein a portion or the entirety of the silane compound is chemically bonded to the inorganic filler.

11. The polycarbonate resin composition according to claim 6, wherein the polycarbonate resin composition has a tensile strength of about 800 kgf/cm² to about 1,500 kgf/cm² measured in accordance with ASTM D638, a flexural strength of about 1,200 kgf/cm² to about 2,000 kgf/cm² measured in accordance with ASTM D790, a flexural modulus of about 30,000 kgf/cm² to about 110,000 kgf/cm² measured in accordance with ASTM D790, an Izod impact strength of about 5 kgf·cm/cm to about 16 kgf·cm/cm as measured on a ⅛″ thick specimen in accordance with ASTM D256, an FDI (falling dart impact) strength of about 10 J to about 40 J as measured on an about 1 mm thick specimen in accordance with the DuPont drop test method, and a melt flow index (MI) of about 10 g/10 min to about 80 g/10 min as measured in accordance with ASTM D1238.
